(19) United States
(12) Patent Application Publication
(10) Pub. No.: US 2013/0290855 A1
(43) Pub. Date: Oct. 31, 2013

(54) Virtual shared office bulletin board

(71) Applicants: Britt C. Ashcraft, Tomball, TX (US); Eric Chen, Houston, TX (US); Rudy Widiaman, Houston, TX (US)

(72) Inventors: Britt C. Ashcraft, Tomball, TX (US); Eric Chen, Houston, TX (US); Rudy Widiaman, Houston, TX (US)

(21) Appl. No.: 13/459,235

(22) Filed: Apr. 29, 2012

(51) Int. Cl. G06F 3/01; G06F 15/16

(52) U.S. Cl. 715/738

(57) ABSTRACT

A method is provided for sharing files between computers. The method includes presenting an interface of a bulletin board application in a program window on a desktop of a computer. The user interface includes a background and file icons on the background. The background includes an image of a bulletin board. The file icons each includes an image of a corresponding physical media and the file icons represents shared files that are accessible to the computer and other computers.

### BACKGROUND

A file hosting service allows users to share computer files and folders with others across a network using file synchronization. File synchronization is the process that updates the computer files at two or more locations to ensure they are consistent.

### BRIEF DESCRIPTION OF THE DRAWINGS

In the drawings:

FIG. 1 illustrates an application icon for a virtual shared office bulletin board application on a desktop of a computer in one example of the present disclosure;

FIG. 2 illustrates a drag-and-drop operation for sharing a computer file in one example of the present disclosure;

FIG. 3 illustrates a user interface for the virtual shared office bulletin board application in one example of the present disclosure;

FIG. 4 illustrates a “borrow” operation for removing a computer file from a virtual shared office bulletin board in one example of the present disclosure;

FIG. 5A is a block diagram of a computer system for file sharing via the virtual shared office bulletin board in one example of the present disclosure;

FIG. 5B is a block diagram of a computing device for file sharing via the virtual shared office bulletin board in one example of the present disclosure;

FIG. 6A is a flowchart of a method for a processor on a computer to execute instructions for the virtual shared office bulletin board application to share files in one example of the present application;

FIG. 6B is a flowchart of a variation of the method of FIG. 6A in another example of the present application;

FIG. 7 is a flowchart of a method for a processor on a computer to execute instructions for the virtual shared office bulletin board to borrow a file in one example of the present application;

FIG. 8 is a flowchart of a method for a processor on a computer to execute instructions for the virtual shared office bulletin board application to remove old pinned computer files from the virtual shared office bulletin board in one example of the present application; and

FIG. 9 is a flowchart of a method for a processor on a computer to execute instructions for the virtual shared office bulletin board application to add notes in one example of the present application.

Use of the same reference numbers in different figures indicates similar or identical elements.

### DETAILED DESCRIPTION

The user experience for sharing files between users, such as coworkers, leaves much to be desired. The user experience generally involves dragging and dropping computer files into a share folder. This is a very digital experience that ostracizes the users from fully taking advantage of file sharing.

In examples of the present disclosure, a virtual shared office bulletin board provides a dynamic user experience that blurs the line between the digital world and reality. The virtual shared office bulletin board has the appearance of a physical bulletin board and represents a designated area on a server assigned to a group of users. A user can drag and “pin” a computer file, such as a word processing documents, a presentation, a song, or a video, onto the virtual shared office bulletin board. Other users can pick up the computer file (e.g., open up the computer file in an application) or borrow it (e.g., remove it from the virtual shared office bulletin board) from the virtual shared office bulletin board.

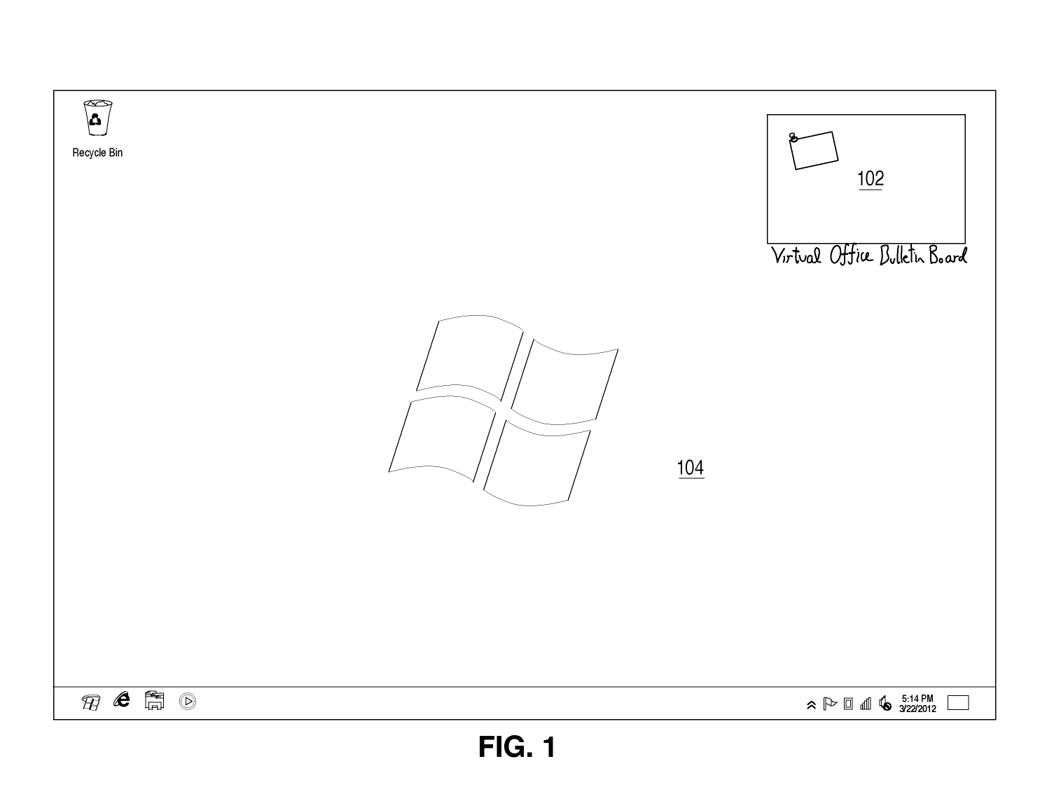

FIG. 1 illustrates an application icon 102 for a virtual shared office bulletin board application (hereafter “bulletin board application”) on a desktop 104 of a computer in one example of the present disclosure. Bulletin board application provides access to a virtual shared office bulletin board, which represents server storage space assigned to a group of users for file sharing. Application icon 102 includes an image of a physical bulletin board and an application name below the image. In one example, the image may include a pinned document for added realism. In another example, application icon 102 is a low resolution version of the actual user interface for the bulletin board application. Desktop 104 is the primary user interface of the operating system on the computer and may include the usual task bar, menu bar, and file, folder, application icons.

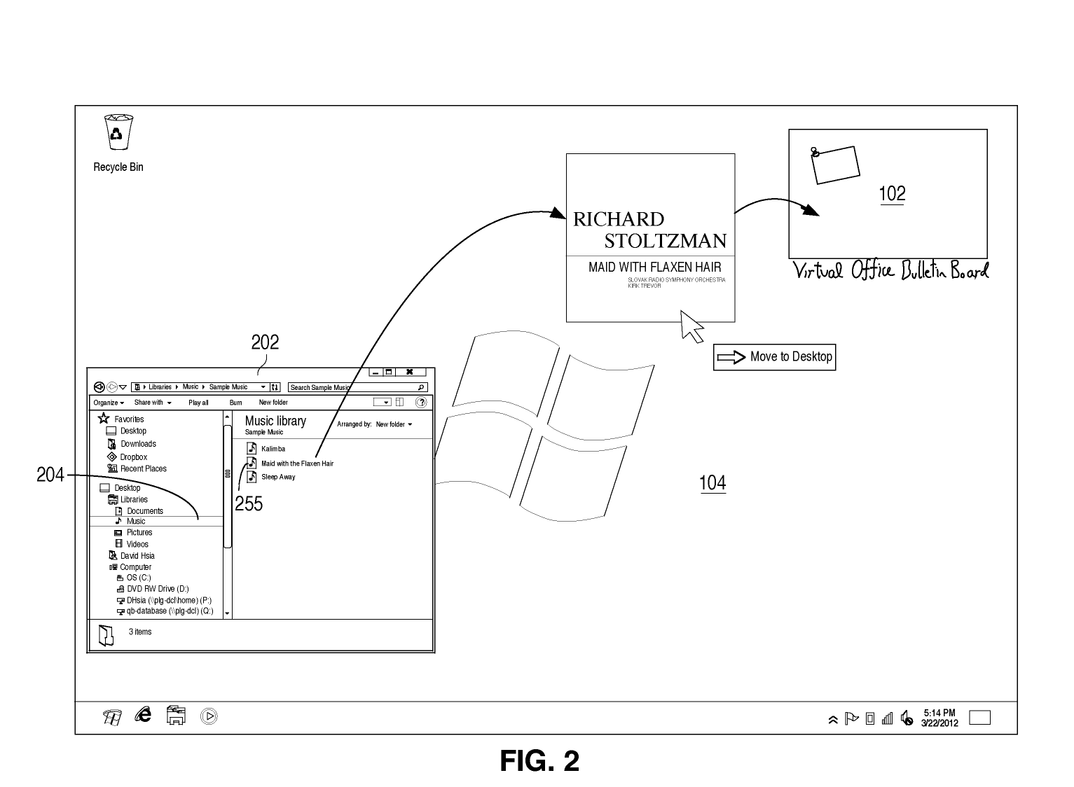

FIG. 2 illustrates the drag-and-drop (also referred to as “drag-and-pin”) operation for sharing a computer file between computers in one example of the present disclosure. On desktop 104, a file explorer 202 is opened to show a folder or a library 204 with a computer file 206 (e.g., an audio file). To share computer file 206, the user drags computer file 206 from folder 204 and drops it onto application icon 102 to pin computer file 206 to the virtual shared office bulletin board. The shared computer file 206 is then accessible to all the assigned users through the bulletin board applications on their computers. The drag-and-pin operation may be accomplished using a mouse, a touch pad, a touch screen, or other similar input devices. The drag-and-pin operation may copy or move computer file 206 from its source to the virtual shared office bulletin board. To open the bulletin board application, the user double clicks or otherwise selects application icon 102.

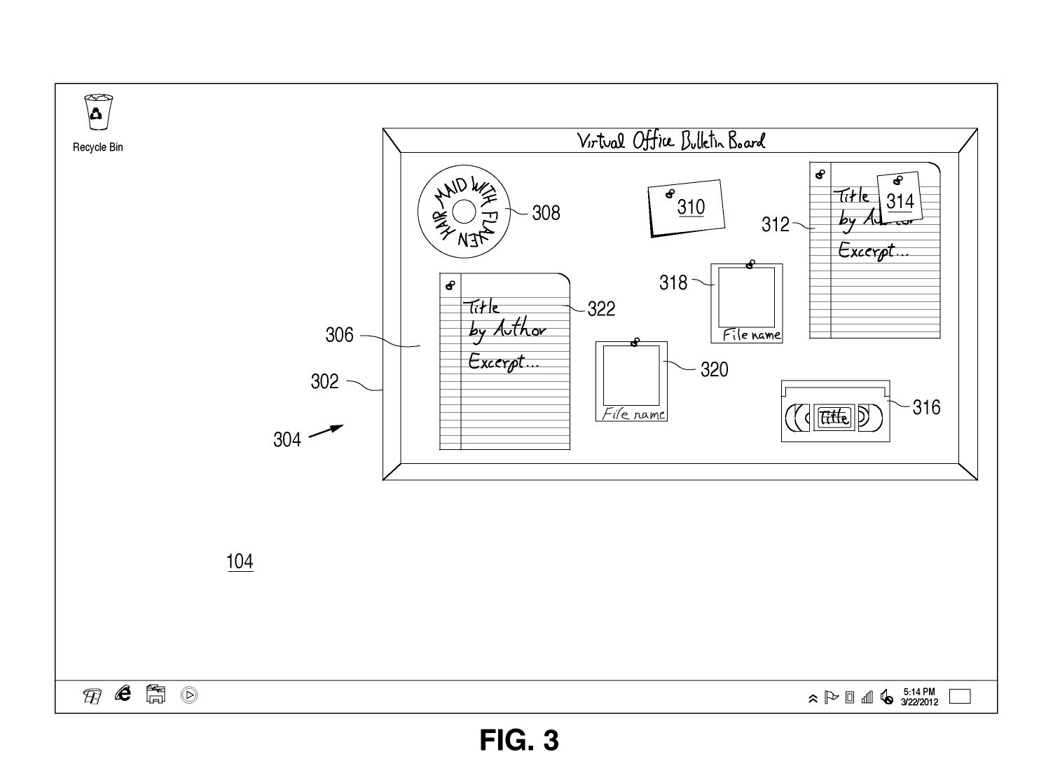

FIG. 3 illustrates a user interface 302 for a bulletin board application 304 in one example of the present disclosure. User interface 302 has a background image 306 of a physical bulletin board and file icons on background image 306. Each file icon has an image that reflects the traditional physical media of the content in the corresponding computer file. The file icons may have proportional sizes for added realism.

Exemplary file icons 308, 310, 312, 314, 316, 318, 320, and 322 are provided for illustrative purposes. File icon 308 is an audio file (e.g., a song) and has an image of a compact disc (CD). File icon 308 may have the title of the song or the name of the file written on the CD. File icons 312 and 322 are word processing files and each has an image of a sheet of notebook paper. File icons 312 and 322 may each have an excerpt of the text from the corresponding word processing file reproduced on the sheet of notebook paper. File icon 316 is a video file (e.g., a movie) and has an image of a video cassette. File icon 316 may have the title of the video written on videocassette. File icons 318 and 320 are image files (e.g., photos) and each has an image of a Polaroid picture. File icons 318 and 320 may each have a thumbnail of the corresponding image file reproduced on the image portion of the Polaroid picture and the file name at the bottom border of the Polaroid picture.

The user may add a generic note to the virtual shared office bulletin board or to a specific note pinned to a computer file. To add a general note to the virtual shared office bulletin board, the user selects a menu or right clicks background image 306 and selects the option to create a note from the menu. To add a specific note to a computer file, the user selects a menu or right clicks the file icon of the computer file and selects the option to create a note from the menu. In response, a window is generated for the user to author the note. File icons 310 and 314 are notes and each has an image of a post-it note. File icons 310 and 314 each may have an excerpt of the text from the corresponding note reproduced on the icon image. File icon 314 is specific to the computer file of file icon 312 so it is shown pinned to file icon 312.

The user double clicks or otherwise selects a file icon to pick up (i.e., open) the computer file in an application. When bulletin board application 304 is opened, the user can also perform drag-and-pin operation to copy or move a computer file to the virtual shared office bulletin board. When a computer file is pinned to the virtual shared office bulletin board, a new file icon is created to represent the computer file on user interface 302. In one example, bulletin board application 304 deletes any computer file that has been pinned to the virtual bulletin board for longer than an allowed post time.

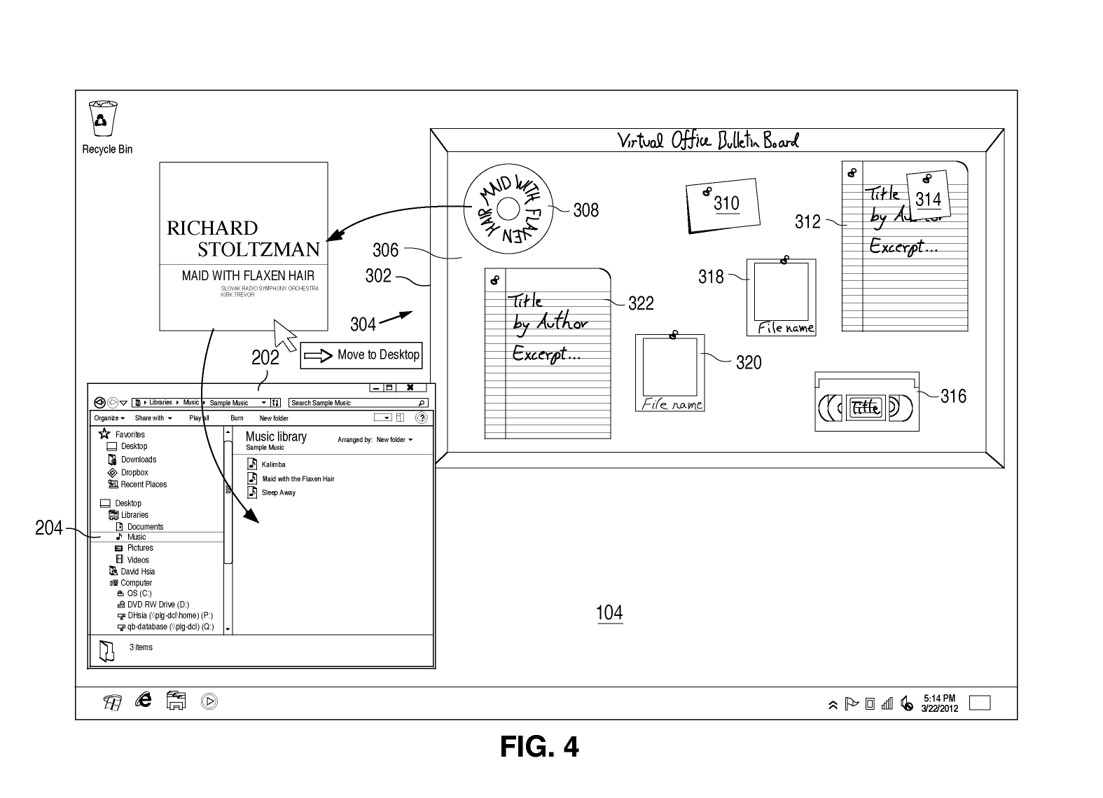

FIG. 4 illustrates a “borrow” operation for removing a computer file from the virtual shared office bulletin board in one example of the present disclosure. On desktop 104, file explorer 202 is opened to show a folder or a library 204. To borrow computer file 206 represented by file icon 308, the user drags file icon 308 from user interface 302 and drops it into folder 204. File icon 308 is then removed from the virtual shared office bulletin board so it is not accessible to the assigned users through bulletin board applications 304 on their computers. The borrow operation may be accomplished using a mouse, a touch pad, a touch screen, or other similar input devices. In one example, bulletin board application 304 automatically returns computer file 206 to the virtual shared office bulletin board when computer file 216 has been borrowed longer than an allowed checkout time.

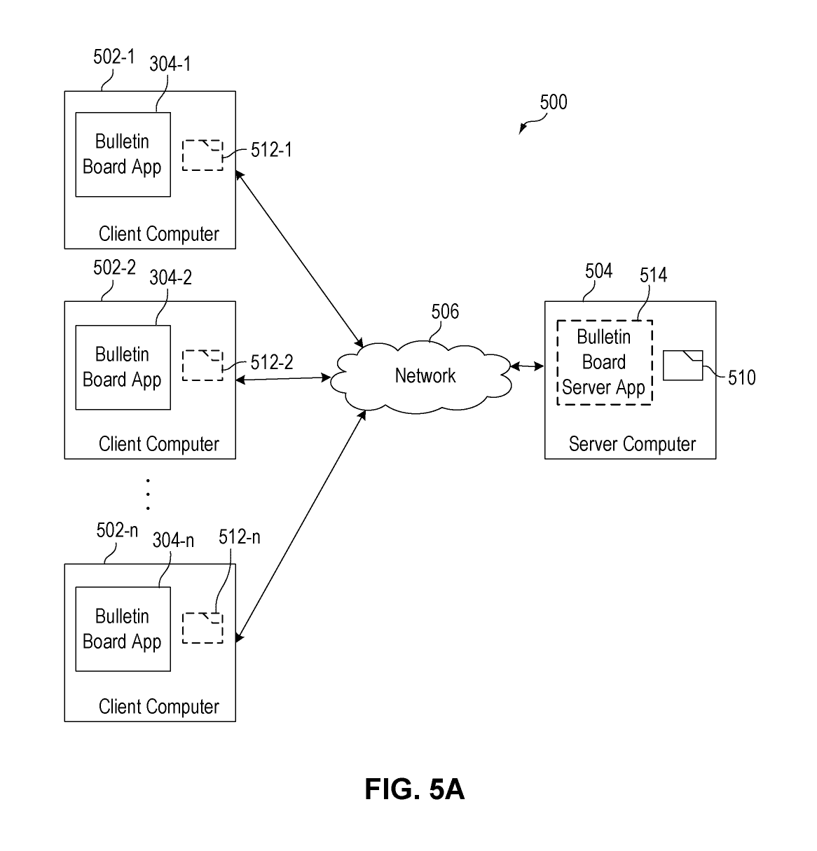

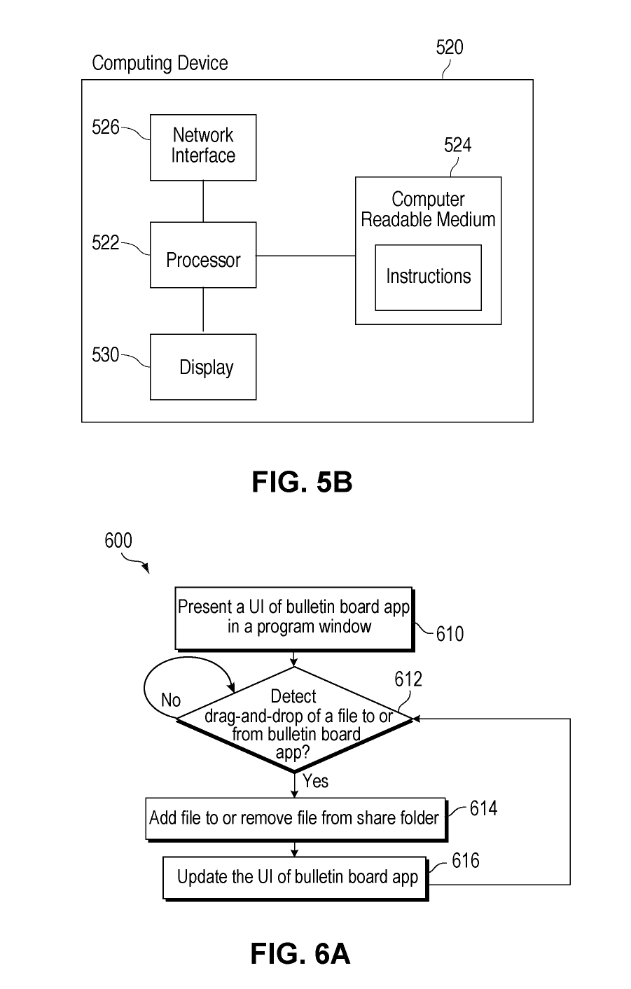

FIG. 5A is a block diagram of a computer system 500 for file sharing via a virtual shared office bulletin board in one example of the present disclosure. System 500 includes client computers 502-1, 502-2 . . . 502-n (hereafter referred to as “client computers 502” collectively or “client computer 502” for a generic individual client computer), a server computer 504, and a network 506 coupling client computers 502 and server computer 504.

In one example, client computers 502-1, 502-2 . . . 502-n run bulletin board applications 304-1, 304-2 . . . 304-n (hereafter referred to as “bulletin board applications 304” collectively or “bulletin board application 304” for a generic individual bulletin board application), and server computer 504 includes a share folder 510 assigned to the users of client computers 502 for storing shared computer files. When a user at a computer 502 pins a computer file to the virtual shared office bulletin board, the corresponding bulletin board application 304 sends the computer file or a copy of the computer file to share folder 510. When the other bulletin board applications 304 detect the new computer file in share folder 510, they update their user interfaces to add a new file icon. Vice versa, when a user borrows a computer file from the virtual shared office bulletin board, the corresponding bulletin board application 304 removes the computer file from share folder 510. When the other bulletin board applications 304 detect the removal of the computer file from share folder 510, they update their user interfaces to remove the corresponding file icon.

In another example, each client computers 502-1, 502-2 . . . 502-n also include local share folders 512-1, 512-2 . . . 512-n, respectively, and server computer 504 includes a bulletin board server application 514. Local share folders 512 are synchronized with share folder 510 on server computer 504 so they are consistent. Having a local copy allows each user to access local copies of the computer files when server computer 504 or network 506 is offline. Instead of each bulletin board application 304 periodically checking for changes to share folder 510, bulletin board server application 514 can push updates (i.e., new computer files) to bulletin board applications 304 on computers 502.

FIG. 5B is a block diagram of a computer device 520 for file sharing via a virtual shared office bulletin board in one example of the present disclosure. Bulletin board application 304 is implemented with processor executable instructions 525 stored in a non-transitory computer medium 524, such as hard disk drive, a solid state drive, or another nonvolatile computer memory. The processor 522 of client computer 502 executes the instructions to provide the described features and functionalities which may be implemented by sending instructions to the network interface 526 or the display 530. Similarly bulletin board server application 514 is implemented with processor executable instructions stored in a non-transitory computer medium, and the processor of server computer 504 executes the instructions to provide the described features and functionalities.

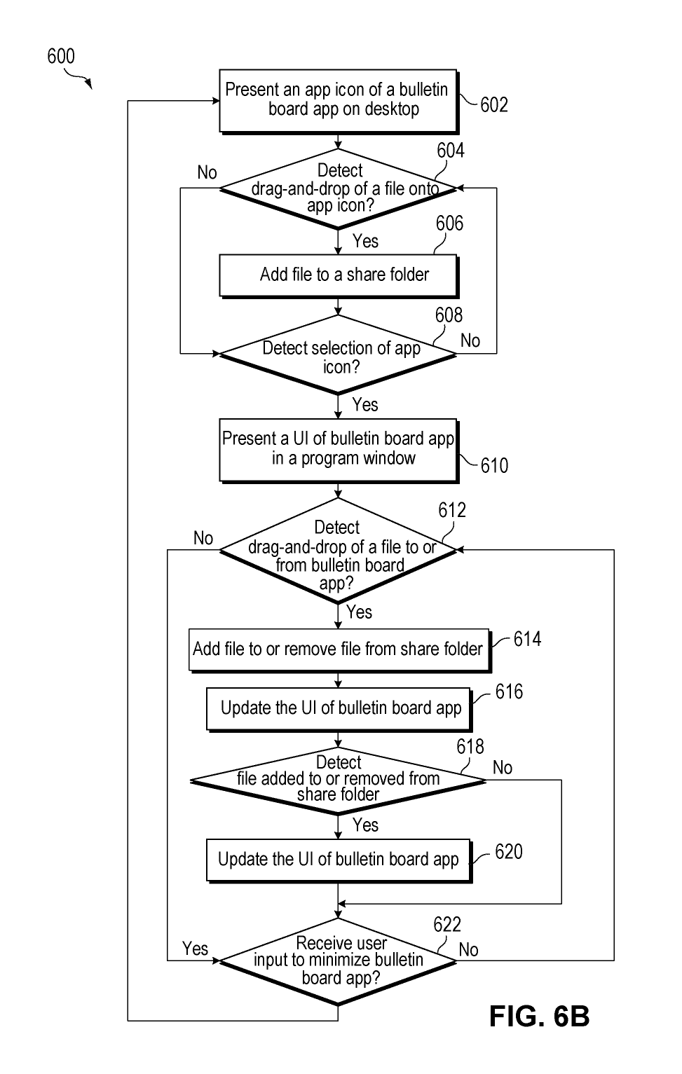

FIG. 6A is a flowchart of a method 600 for a processor on computer to execute instructions for bulletin board application 304 to share files in one example of the present application. A drag-and-drop operation can be detected such that a file is pined to the interface of the bulletin board application at 612. In response to detecting the drag-and-drop operation at 612 the file can be added to a share folder on a server computer accessible to the computer and the other computers at 614. The interface of the bulletin board application can be updated with a file icon for the file on the background at 616.

FIG. 6B is a flowchart of a variation of method 600 in another example of the present application. Method 600 begins in block 602.

In block 602, the processor presents application icon 102 of bulletin board application 304 on desktop 104 of computer 502. Block 602 is followed by block 604.

In block 604, the processor determines if a computer file has been dragged-and-dropped onto application icon 102. If so, block 604 is followed by block 606. Otherwise block 604 is followed by block 608.

In block 606, the processor adds the computer file to share folder 510. The processor may also add the computer file to local share folder 512. Block 606 is followed by block 608.

In block 608, the processor determines if application icon 102 has been double-clicked or otherwise selected. If so, block 608 is followed by block 610. Otherwise block 608 is followed by block 604.

In block 610, the processor presents user interface 302 of bulletin board application 304 in a program window. Block 610 is followed by block 612.

In block 612, the processor determines if a computer file has been dragged-and-dropped onto user interface 302 or dragged-and-dropped from user interface 302. If so, block 612 is followed by block 614. Otherwise block 612 is followed by block 622.

In block 614, the processor adds or removes the computer file from share folder 510 depending on the action in block 612. The processor may also add or remove the computer file from local share folder 512. Block 614 is followed by block 616.

In block 616, the processor updates user interface 302 to reflect the change to share folder 510. Block 616 is followed by block 618.

In block 618, the processor determines if share folder 510 has changed (i.e., if any computer file has been added or removed). The processor may monitor share folder 510 to detect any changes or bulletin board server application 514 may inform the processor of any changes. If share folder 510 has changed, block 618 is followed by block 620. Otherwise block 618 is followed by block 622.

In block 620, the processor updates user interface 302 to reflect the change to share folder 510. The processor may also update local share folder 512 to reflect the change to share folder 510. Block 620 is followed by block 622.

In block 622, the processor determines if bulletin board application 304 has been minimized by the user. If so, block 620 is followed by block 602. Otherwise block 620 is followed by block 612.

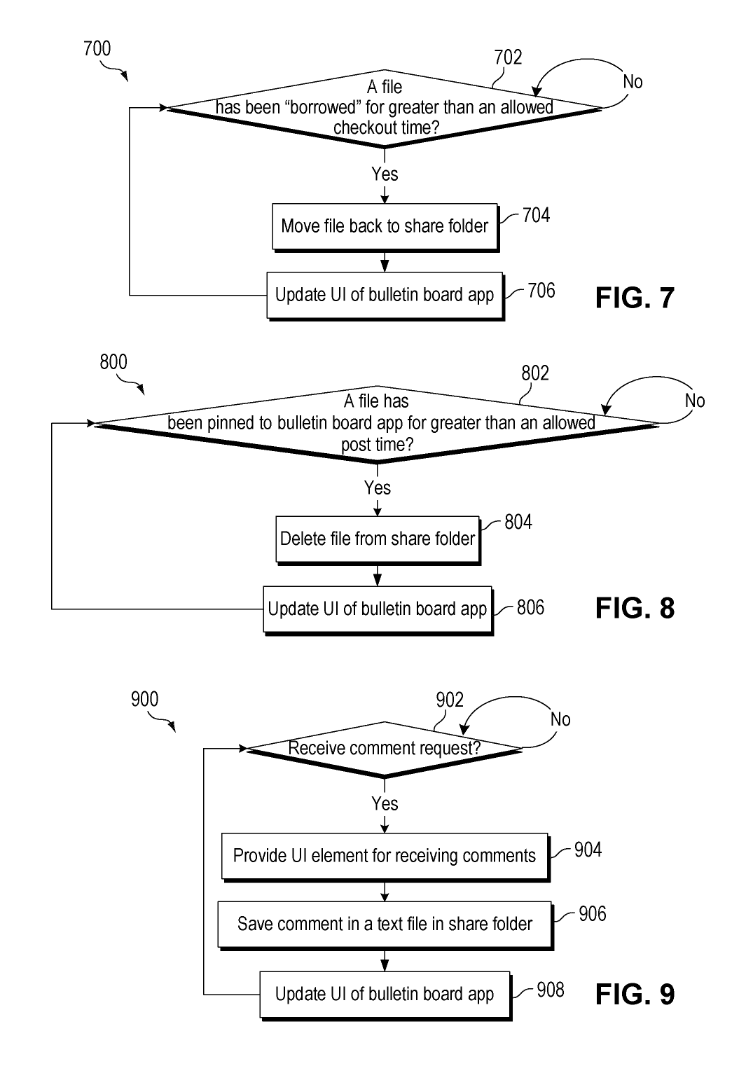

FIG. 7 is a flowchart of a method 700 for a processor on computer 502 to execute instructions for bulletin board application 304 to borrow a computer file in one example of the present application. Method 700 begins in block 702.

In block 702, the processor determines if a computer file has been borrowed (e.g. removed) from share folder 510 for greater than an allowed checkout period. If so, block 702 is followed by block 704. Otherwise block 702 loops back to itself.

In block 704, the processor moves the computer file back to share folder 510. Block 704 is followed by block 706.

In block 706, the processor updates user interface 304 to reflect the change to share folder 510. Block 706 is followed by block 702.

FIG. 8 is a flowchart of a method 800 for a processor on computer 502 to execute instructions for bulletin board application 304 to remove old pinned computer files from the virtual shared office bulletin board in one example of the present application. Method 800 begins in block 802.

In block 802, the processor determines if any computer file has been pinned to the virtual bulletin board (e.g., added to share folder 510) for greater than an allowed post time. If so, block 802 is followed by block 804. Otherwise block 802 loops back to itself

In block 804, the processor deletes the computer file from share folder 510. Alternatively, the processor moves the computer file back to its source location. Block 804 is followed by block 806.

In block 806, the processor updates user interface 304 to reflect the change to share folder 510. Block 806 is followed by block 802.

FIG. 9 is a flowchart of a method 900 for a processor on computer 502 to execute instructions for bulletin board application 304 to add notes in one example of the present application. Method 900 begins in block 902.

In block 902, the processor determines if a user has requested to add a comment to the virtual shared office bulletin board or a computer file pinned to the virtual shared office bulletin board. If so, block 902 is followed by block 904. Otherwise block 902 loops back to itself

In block 904, the processor provides a user interface element (e.g., a window) for receiving comment. Block 904 is followed by block 906.

In block 906, the processor saves the comment in a text file in share folder 510. If the comment is specific to a pinned computer file, the text file identifies the name of the computer file. Block 906 is followed by block 908.

In block 908, the processor updates user interface 304 to reflect the change to share folder 510. Block 908 is followed by block 902.

Various other adaptations and combinations of features of the examples disclosed are within the scope of the invention. Numerous examples are encompassed by the following claims.

What is claimed is:

1. A method for sharing files between computers comprising:
presenting an interface of a bulletin board application in a program window on a desktop of a computer, the interface including a background and file icons on the background, the background including an image of a bulletin board, the file icons each including an image of a corresponding physical media, and the file icons representing shared files that are accessible to the computer and other computers;
detecting a drag-and-drop operation that pins a file to the interface of the bulletin board application; and
in response to detecting the drag-and-drop operation:
adding the file to a share folder on a server computer accessible to the computer and the other computers; and
updating the interface of the bulletin board application with a file icon for the file on the background.

2. The method of claim 1, wherein a shared word processing file is represented by a file icon having an image of at least one sheet of paper and a pin so the at least one sheet of paper appears to be pinned to the bulletin board.

3. The method of claim 2, wherein the file icon further comprises an excerpt from the shared word processing file on the at least one sheet of paper.

4. The method of claim 1, wherein a shared audio file is represented by a file icon having an image of a compact disc.

5. The method of claim 1, wherein a shared image file is represented by a file icon having an image of a Polaroid picture.

6. The method of claim 1, wherein a shared video file is represented by a file icon having an image of a videocassette.

7. The method of claim 1, wherein the file icons each further comprises a file name on the image.

8. The method of claim 1, further comprising:
after an allowed post time has passed since the file was copied or moved to the share folder:
removing the file from the share folder; and
updating the interface of the bulletin board application to remove the file icon.

9. The method of claim 1, further comprising:
detecting a drag-and-drop of another file icon from the interface of the bulletin board client application to a destination;
moving another file represented by the other file icon from the share folder at to the destination; and
updating the interface of the bulletin board client application to remove the other file icon.

10. The method of claim 9, wherein the drag-and-drop of the other file icon comprises a borrowing of the other file, the method further comprising:
after an allowed checkout time has passed since the other file was moved to the destination, determining if the other file has been moved back to the share folder;
when the other file has not been moved back to the share folder, moving the other file from the destination to the share folder; and
updating the interface of the bulletin board client application to include the other file icon.

11. The method of claim 1, further comprising:
providing an interface element for receiving comments;
receiving a comment via the interface element;
in response to receiving the comment:
generating a text file with the comment in the share folder;
presenting a comment icon on the background image, the comment icon representing the text file.

12. The method of claim 11, wherein the comment icon has an image of a post-it note.

13. The method of claim 12, further comprising associating the comment file with a shared file, wherein the post-it note is placed atop a file icon of the file.

14. The method of claim 1, further comprising, when the interface of the bulletin board application is minimized:
presenting an application icon of the bulletin board application on the desktop of the computer, the application icon comprising an image of another bulletin board or the interface of the bulletin board application;
detecting a drag-and-drop of a file onto the application icon; and
in response to detecting the drag-and-drop of the file onto the application icon, adding the file to a share folder at a server computer.

15. A non-transitory computer-readable storage medium comprising executable instructions for execution by a processor of a computer to share files between computers including the computer, the instructions comprising:
presenting an image of a bulletin board on a display of the computer;
presenting images of files on the image of the bulletin board, the files being shared between the computers through the bulletin board;
notifying a bulletin board server of a placement of a file on the bulletin board;
adding an image of the file on the image of the bulletin board on the computer;
notifying the bulletin board server of a removal of the file from the bulletin board; and
removing the image of the file from the image of the bulletin board on the computer.

16. The non-statutory computer-readable storage medium of claim 15, wherein the images of the files each includes an image of a corresponding physical media

17. The non-statutory computer-readable storage medium of claim 15, wherein the instructions further comprise:
when the interface of the bulletin board is minimized, presenting an icon of the bulletin board; and
when another file is placed on the icon, notifying the bulletin board server of the placement of the other file on the icon.

18. A computing device, comprising:
a display to display an image of a bulletin board and an image of a file;
a transceiver to connect the computing system to a network; and
a processor to notify a bulletin board server of a removal of the file from the bulletin board on the computer, notify the bulletin board server of a placement of the file on the bulletin board, remove an image of a file indicated by the bulletin board server as being removed from the bulletin board by another computer, and add an image of a file indicated by the bulletin board server as being placed on the bulletin board by another computer.

19. The computing device of claim 18, wherein the images of the files each includes an image of a corresponding physical media

20. The computing device of claim 18, wherein the processor to:
when the bulletin board is minimized, present an icon of the bulletin board on the display; and
when another file is placed on the icon, notify the bulletin board server of the placement of the other file on the icon.
